(19) United States
(12) Patent Application Publication
(10) Pub. No.: US 2017/0140445 A1
(43) Pub. Date: May 18, 2017

(54) System and Method for Determining the Market Value of a Diamond

(71) Applicants: Justin P. Carmody, Kensington, MD (US); Matthew Thomas Carmody, North Hollywood, CA (US)

(72) Inventors: Justin P. Carmody, Kensington, MD (US); Matthew Thomas Carmody, North Hollywood, CA (US)

(21) Appl. No.: 15/350,054

(22) Filed: Nov. 12, 2016

Related U.S. Application Data
(60) Provisional application No. 62/285,899, filed on Nov. 12, 2015.

(51) Int. Cl. G06Q 30/02

(52) U.S. Cl. CPC G06Q 30/0283; G06Q 30/0281

(57) ABSTRACT

The disclosure relates to a system and method for valuation and publication of a diamond's market value that connects diamond purchasers to diamond sellers and provides to both a reasonable estimate of the diamonds fair market value. The invention analyzes a diamond's physical properties and compares it to international wholesale prices for similar stones, adjusts the price based on these criteria, stores this information in an accessible means, and then provides the information to buyer of the diamond.

### CROSS REFERENCE TO RELATED APPLICATIONS

The present application claims priority to provisional application 62/285,899 also titled “System and Method for Determining the Market Value of a Diamond,” filed on Nov. 12, 2015, the complete disclosure of which is incorporated herein by reference.

### FIELD OF THE DISCLOSURE

The field of the invention is electronic commerce technologies, particularly the electronic commerce technologies relating to diamonds.

### BACKGROUND OF THE DISCLOSURE

The evaluation and sale of diamonds in retail environments is a transaction where the buyer and seller are both at unique disadvantages. Nearly all retail buyers lack the knowledge needed for a fair valuation or appraisal of the gemstone they are purchasing, and must rely entirely on the seller's information regarding the gems quality. This information typically includes the quality of the diamonds cut, clarity, color and carat weight. However, aside from carat weight, retail buyers lack a basis for judging cut, color and clarity. Most scales of measurement are based on fixed references such as model stones, but an independent gemstone appraiser or seller has considerable leeway in determining where, within a particular classification, a gemstone would ultimately rank. Various written guides do exist, but while these guides may provide information on the types of cuts, colors, and other facets of diamond appraisal, the actual evaluation of a diamond is a professional undertaking, one that should only be performed by trained gemologists such as those trained at the Gemological Institute of America (GIA), from the American Gem Society (AGS), or from HRD Antwerp (HRD). Moreover, when appraisals are performed outside of a professional lab, even when performed by a lab-trained gemologist, the appraisal will often be erroneously inflated as these appraisals are done by the seller or at the seller's request, and thus are biased to a price higher than a fair market value.

That said, seller is similarly disadvantaged. The return on investment for advertising is limited at best in this rarified market. Most buyers recognize the disparities in knowledge and are distrustful of sellers that are not personally know to them. Diamond merchants often rely heavily on word-of-mouth and repeat customers for their core business. As such, the online sale of gemstones has had little success. Moreover, given the limited availability of information on the retail market value of stones, while a diamond of particular cut, clarity, color and carat size may sell for $10,000 dollars in one store, an essentially identical diamond may sell for $5,000 at a neighboring store. This does not work entirely in the seller's favor, as the buyer will have a cause of action for a diamond that is significantly and incorrectly assessed by the seller. At least one expert estimates that the pending but un-litigated liability for incorrectly assessed and priced diamonds sold to consumers is on the order of a billion dollars. This is in essence an inefficient market place with significant disadvantages to both seller and buyer.

### BRIEF SUMMARY OF THE DISCLOSURE

Therefore, there is a need in the art for a method that improves the sales of diamonds by increasing the transparency between seller and buyer by efficiently disseminating accurate estimates and true market values of a diamond to the buyer or seller along with the location of the diamond seller where the diamond is offered for sale. Accordingly, the invention relates a method and system for valuation and publication of a diamond's market value and connecting diamond purchasers to sellers, comprising,
providing at least one submission by a diamond seller, the submission comprising an asking price for the diamond, the seller's geographic location, and a set of identifying characteristics of the diamond including at least one of the diamond's shape, cut grade, color, clarity and the carat weight (mass);
storing the at least one submission in a computer readable media, wherein the estimate, geographic location and identifying characteristics are stored in a database and organized in the readable media such that all of the submissions in the readable media may searched according to these characteristics;
acquiring an international standard wholesale price (ISWP) for the diamond in the readable media;
adjusting the standard wholesale price up or down based on the diamond's identifying characteristics to produce a fair market value for the diamond, and optionally, storing the fair market value in the database readable media; and
transmitting the fair market value to a potential buyer, and, optionally, in whole or in part, the seller's submission including the asking price for the diamond, the seller's geographic location, and the set of identifying characteristics of the diamond.

In one embodiment, the step of transmitting the fair market value includes the steps of the buyer accessing said readable media from a remote location using a browsing device, wherein said step of accessing said readable media is performed by a buyer using an application or web browser operating on said browsing device; inputting a request by a buyer for a diamond, said request including price, geographic location and comprising at least one parameter, the parameter including, at least one of an upper or lower boundary for price, color, carat; cut style and cut quality; comparing the request with the stored submissions and retrieving at least one submission that falls within the location and parameters of the request; transmitting from the readable media onto the browsing device the at least one submission, including the asking price, the fair market value, and seller's location; and displaying the at least one submission, fair market value, and seller's location on the browsing device. In one embodiment, the submission also includes a certificate by the GIA certifying the identifying characteristics.

In one embodiment, the submission also includes cut proportions, and fluorescence. In one embodiment, submissions are to only white diamonds. In one embodiment, submissions are to diamonds with color of faint yellow (M) or better. In one embodiment, the price provided by the diamond seller, the geographic location of the diamond seller, and a fair market value are provided and displayed with the results.

In one embodiment, the fair market value is calculated by taking an industry standard wholesale price and adjusting the price to reflect the individual diamonds characteristics. In one embodiment, adjusting the price includes discounting/marking up the estimate of the diamond's fair market value (FMV) based on the diamonds color, carat weight, cut and clarity. In one embodiment, the FMV is calculated by adjusting the international wholesale price between plus or minus 0-85% based on the condition of the aforementioned color, carat weight, cut and clarity, preferably between plus or minus 0-65%, more preferably plus or minus 0-50%, and more preferably plus or minus 0-35%, and more preferably plus or minus 0-25%. In one embodiment, the FMV is also calculated based on the cut grade, symmetry, polish, and fluorescence.

In one embodiment, the estimate of price is adjusted downwards or discounted by from 5-50% if the cut grade is fair to poor. In one embodiment, the price is adjusted downwards or discounted by 5-25% if the symmetry is fair to poor. In one embodiment, the price is adjusted downward or discounted by 5-25% if the polish is fair to poor. In one embodiment, the price is adjusted downward or discounted by 5-25% if there is detectable fluorescence. In one embodiment, the submissions include fluorescence, treatments given to the diamond, or the location of the diamond seller.

In one embodiment, the step of inputting a request by the buyer includes inputting a geographic limitation on the search, such as the maximum distance from the buyer. In one embodiment, this distance is entered by a pull down menu, where the maximum distance is in increments.

In one embodiment, the step of displaying the submission(s) includes displaying the certificate, the asking price, the fair market value, and the seller's location(s). In one embodiment, the step of displaying also includes displaying the percentage discount or mark up of the stone relative to the international wholesale price. In one embodiment, the step of displaying also includes displaying the difference between the asking price and the fair market value. In one embodiment, the step of displaying also includes displaying the percentage discount or mark-up of the stone relative to the asking price.

### DESCRIPTION OF THE DRAWINGS

The present invention is more fully disclosed in the following detailed description and the accompanying drawings, including:

FIG. 1. depicts a block diagram of the process of the invention.

FIG. 2 depicts an example of a seller upload form webpage provided by the system to a diamond seller via a webpage generated by the system.

FIG. 3 depicts an example of a request input by a diamond buyer provided by the system to a diamond buyer via a webpage generated by the system, and output provided by the system.

FIG. 4 depicts another example of a request input by a diamond buyer provided by the system to a diamond buyer via a webpage generated by the system.

FIG. 5 depicts a result provided to the buyer by the system.

FIG. 6 depicts a schematic diagram of the system.

### DETAILED DESCRIPTION OF THE DISCLOSURE

The foregoing general description and the following detailed description are exemplary and explanatory only and are not restrictive of the invention, as defined in the appended claims. Accordingly, what follows is a discussion of the preferred aspects of the present invention, and of a preferred method and system of operation of the invention. It is appreciated by those of skill in the art that the process may be described in a functional block diagram of components and various processing steps, and that the function blocks of the process may be performed by any number of the appropriate software or electronic/hardware components configured to perform the specified functions or steps in the process. For example, the present invention is preferably performed using integrated circuit components, such as memory elements, including random access memory or read only memory, digital signal processing elements, logic elements, look-up tables, and the like. Typically, these components then carry the appropriate set of steps or functions under the control of at least one microprocessors. In addition, those skilled in the art will appreciate that the present invention may be practiced in conjunction with one or more existing computer networks, and that the system described herein is merely one exemplary application for the invention.

It should be appreciated that the particular implementations shown and described herein are illustrative of the invention and are not intended to otherwise limit the scope of the invention in any way. Conventional techniques for data processing, data transmission, information displays, statistical analysis, computer operating systems, and other functional aspects of the systems (and the individual operating components of the systems) may not be described in detail herein. Furthermore, the connecting lines shown in the various figures contained herein are intended to represent exemplary functional relationships and/or physical couplings or information exchange between the various elements. It should be noted that many alternative or additional functional relationships or physical connections may be present in a practical embodiment.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting. Further, for the sake of clarity, the following definitions are provided for several commonly used terms. Terms related to gemstone evaluation are used typically in the industry and defined by the Gemological Institute of America. The Gemological Institute of America, Inc. of Carlsbad, Calif. (GIA) is a non-profit (Sec. 501(c)(3)), non-governmental professional organization that evaluates and trains gemologists as professional evaluators in the grading of gemstones including diamonds.

The use of “a” or “an” are employed to describe elements and components of the invention. This is done merely for convenience and to give a general sense of the invention. This description should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

A “browsing device” is a computer in communication with a network that has access to the internet or may connect to the internet using a web browsing program. Exemplary devices include tablet computers, handheld smart-phones, laptops and desktop computers and work stations. Exemplary web browsing programs include all commercially available web browsing programs such as Internet Explorer®, Chrome®, Firefox®, and Safari®. Computers typically are composed of a central processor unit (CPU), storage media (both non-transitory/permanent and transitory memory), one or more input devices (keyboard, mouse, voice recognition, touchpad, and the like), and, optionally, peripheral output devices such as displays and printers. The processor is the electronic circuitry within a computer that carries out the instructions of a computer program by performing the basic arithmetic, logical, control and input/output (I/O) operations as directed by the computer program. The processor is typically linked with or in electronic communication with and/or include integral cache memory. The memory can be, for example, a Random-Access Memory (RAM) (e.g., a dynamic RAM, a static RAM), a flash memory, a removable memory, and/or so forth. The instructions associated with performing the operations of the invention such as storing international price information, adjusting fair market values, etc. are performed by the processor, and where appropriate, the results of these operations can be stored within the memory and/or a storage medium. Typically, in some embodiments, this includes storing information/instructions in a database.

In some instances, the processor includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute those modules/components. The processor can be any suitable processing device configured to run and/or execute a set of instructions or code. For example, the processor can be a general purpose processor, a central processing unit (CPU), an accelerated processing unit (APU), a field-programmable gate array (FPGA), an application specific integrated circuit (ASIC), a digital signal processor (DSP), and/or the like.

The “characteristics” of a diamond as used herein refer to the inherent qualities of the gem that have an impact on its price or market value. Some characteristics include cut, clarity, carat weight and color of the diamond, as well as the cut grade, symmetry, polish and fluorescence of the diamond.

The “color” of a diamond as used herein refers to the GIA scale. For ordinary diamonds, the scale ranges from colorless (D, E, F), near colorless (G, H, I, J), faint yellow (K, L, M), very light yellow (N, O, P, Q, R), light yellow (S, T, U, V, W, X, Y, Z), where diamonds tinted further than “Z” are considered brown diamonds, with colorless diamonds being the most valuable and having the highest market value, and with market value typically diminishing as the color increases in intensity (notwithstanding the newly fabricated marketing schemes for “chocolate” or “mocha” brown diamonds). For diamonds tinted with rare colors like blue, green, or red, and referred to as fancy diamonds in the industry, different scales are used with the market value increasing as the intensity of the color increases.

The “clarity” of a diamond as used herein refers to the appearance of the diamond under 10× magnification as standardized by the GIA. Clarity is reduced by inclusions or blemishes such as polish lines, grain boundaries, scratches, nicks, pits, chips, breaks and dark spots. The scale ranges from Flawless (FL), Internally Flawless (IF), Very Very Slightly Included, (VVS₁ and V₅₅₂), Very Slightly Included (VS₁ and VS₂), Slightly Included (SI₁ and SI₂) and Included (I₁, I₂, and I₃).

The “carat” or “weight” of the diamond as used herein is the diamond's mass in the unit of mass “carat”, which in the metric system is equivalent to 200 milligrams.

Examples of shapes include but are not limited to round, emerald, pear, radiant, asscher, heart, or oval. A given cut will have a preferred set of dimensions, such that the maximum amount of light is transmitted through the diamond's facets.

The “cut” or “cut grade” of the diamond as used herein refers to the objective quality of the shape of the diamond. The cut grade is measured by examining the precision of the facets of the diamonds surfaces or facets in the pavilion. The grading range used by the GIA, for example grades diamonds on a descending scale form Excellent, Very Good, Good, Fair, and Poor. Cut grade is typically determined by analysis of the facets of the diamond that impact the amount and manner of light refracted by the diamond. The qualities of this light, as used herein, are typically referred to as brightness, fire and scintillation. Brightness refers to the amount of internal and external light refracted from the diamond. Fire refers to the refraction of white light by the diamond into colors. Scintillation is the amount of sparkle, or discrete points of light, visible from the diamond's upper surface as well as the pattern of light and dark areas of the diamond. Accordingly, cut grade is determined by measuring the proportions and angles of the cuts and facets found in the above portions of the diamond, e.g. the thickness of the girdle, the depth of the crown and pavilion, etc., and comparing these measurements to standards, as well as the appearance of the diamond, and the quality of its surface appearance. These factors are, as used herein and known in the art described as symmetry and polish. Specific of analysis of cut grade include the GIA's methods, and are available via FacetWare® (www2.gia.edu/facetware/), where parameters for girdle thickness, star length, and the like, are compared to known values. Cut grade is further determined as a product of symmetry and polish. An Excellent cut grade requires both polish and symmetry to be excellent.

A “device readable media” as used herein is a data memory storage device that serves as part of a computer, such as a web server, having a program that executes commands in a computer language, such as HTTP (hypertext transfer protocol) language, that may be a means to receive and store information from remote users (such as diamond sellers), and provide information in response requests from users (such as diamond buyers) requests for web pages.

Some instances described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other instances described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, instances may be implemented using Java, C++, .NET, or other programming languages (e.g., object-oriented programming languages) and development tools. Additional examples of computer code include, but are not limited to, control signals, encrypted code, and compressed code.

The term “diamond” as used herein refers to natural diamonds, as opposed to synthetic diamonds unless otherwise noted. The term “synthetic diamond” refers to an artificially produced diamond (as opposed to a naturally occurring diamond). Synthetic diamonds are typically grown using chemical vapor deposition techniques similar to those used to produce microprocessors wafers containing silicon. At present, although synthetic diamonds are chemically identical to natural diamonds, they sell at prices lower than naturally occurring diamonds. The portions of a diamond are typically described as having a table, girdle, pavilion, and culet. The crown of the diamond is the top most portion, and contains the table. The table is the largest facet of the diamond, and is typically the top most facet when viewed on a longitudinal axis. The pavilion is the bottom section of the diamond, and may contain the culet if present. The culet is the bottom facet of the diamond. The girdle is the ring of facets that separate the crown from the pavilion.

The term “database” refers to a structured or otherwise organized set of data held in a computer memory that is accessible or searchable, with individual elements sorted into categories. For example a database of diamonds might have the information on individual diamonds characteristics stored with values associated with each including location, cut, clarity carat, color, and the like. A search of this database by one or more of these parameters would provide results a list of diamonds with characteristics matching the parameters. In the alternative, a search of a range of characteristics, e.g. carat of 0.5 to 0.75, would provide results of all diamonds and information associated with these diamonds having carat weight within that range (including endpoints).

The term “fluorescence” as used herein refers to the light emitted by the diamond in response to ultraviolet light, where significant fluorescence may detract from the diamonds value by giving it a partially opaque or milky appearance.

The “geographic location” of a diamond dealer is the physical address of the location of the retail store where the diamond will be sold to a retail seller, and thus includes for example, the region, city, and street address of the seller's retail location.

The “remote location” is the location of the diamond buyer where the buyer is geographically separated from the seller.

The “parameter” is a bounded range or discrete value identifying the characteristics, price and location of the diamond that the buyer is interested in purchasing. The parameter for price is a numerical range, and may be either a maximum value (with the lower boundary being zero) or a minimum value (with the upper boundary being unlimited), or fully bounded range having a maximum and minimum value. The parameter for color is in some embodiments the alphabetic range of the color, such as the lower boundary being E and the upper boundary being H (to include E, F, G, and H), a single value (such as “D”) or the descriptive terms may also be used, e.g. a range from colorless to very light yellow. The parameter for clarity is a defined range from flawless (FL) to obvious inclusions (I3) using the GIA scale. Other scales may be included. The parameter for cut may include an identifier of the shape of the diamond and the upper and lower bounds of the quality of the cut of the diamond. The parameter for the location of the diamond may include the geographic region where the diamond is located, such as Northeastern Seaboard, Mid-Atlantic, Pacific Northwest, Midwest, and the like, it may include a defined distance from a set location, such as 1 to 100 miles from the location of the buyer, it may include a state, such as the state where the buyer is located, such as Illinois, or it may include the city where the buyer wishes to purchase the Diamond, such as Washington, D.C., or Atlanta, Ga.

The term “polish” as used herein refers to part of the measurement of the craftsmanship in the diamond's production, particularly the quality of the diamonds surface as a result of surface polishing, the presence of blemishes, or damage to the diamond's surface as part of ordinary wearing from environmental interaction, where the blemishes do note penetrate the surface of the diamond when viewed at 10× magnification. The scale used to measure polish, in ascending order, is Excellent, Very Good, Fair, and Poor.

The term “certificate” refers to a document containing an evaluation of the diamond's characteristics and/or price provided by an independent agency that professionally evaluates gemstones. Exemplary agencies include the GIA, AGS, or the HRD.

The term “symmetry” as used herein refers to the precision of placement of the facets and proportions of the shape of the diamond, and refers to or is the product of the craftsmanship used to produce the diamond. Like polish, symmetry is also graded on the scale of poor to excellent.

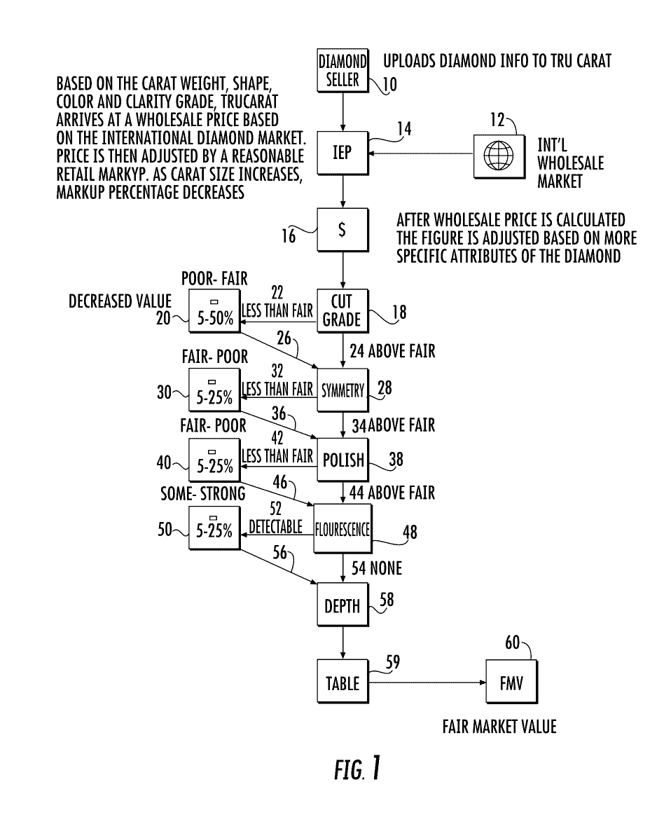

In one embodiment of the system of the invention, the characteristics of the diamond and its international wholesale listing price in its class are used to determine a fair market value of the diamond. FIG. 1. depicts an exemplary process of the invention in block diagram form. Diamond seller 10 provides the criteria for the diamond, including the diamond carat weight, shape, color, and carat grade to the system by loading a web page linked to or containing the system having a form for entering and saving the information into a database being accessed by a web browser where the system stores this information in device readable media, which may in alternative embodiments be a server based program located in a central controller 210.

The system includes or has stored in device readable media information from the International Wholesale Market listing 12, a database that is updated based on published wholesale prices, and from this an initial estimate of the diamond's wholesale price (IEP) 14 is calculated. After this IEP is calculated, the price is adjusted based on the specific attributes of the diamond, and the system in turn makes the following adjustments to the IEP. These adjustment steps may occur sequentially though the order of these adjustment steps may vary, and with each adjustment a new price estimate (NPE) is generated. In the alternative, the percentage of total adjustment may be calculated separately and applied to the IEP in a single calculation to produce only one NPE. Adjustments are typically proportional or near proportional to the variance from or nearness to the highest monetary value quality in increments of 1%, 2%, 3%, 4,%, 5%, or the like. For example, if an adjustment may be made ranging from 5-50% for a characteristic's variance, a minimal variance would by −5%, a larger deviation −6%, a still larger deviation −7%, etc.

In a sequential example of adjusting the IEP, a series of NPEs are produced by discounting the IEP of the diamond depending on its characteristics. For cut grade 18 of less than fair 22, the IEP is reduced by 5-50% 20 for a first NPE, or for cut grade 18 of above fair 34, the NPE is left unchanged. In that case, the first NPE would be equivalent to the IEP. (In an alternative embodiment, the NPE may be increased by 5-25% for cut grade above fair.)

The system then adjusts the NPE based on the symmetry of the diamond 28. For symmetry 28 of less than fair 32, the first NPE is reduced by 5-25% for a second NPE, and for symmetry 28 of above fair 34, the NPE is left unchanged. (In an alternate embodiment, for a symmetry 28 of above fair 34, the NPE may be increased by 5-25%.)

For polish 38 of less than fair 42, the second NPE is reduced 5-25% 40 for a third NPE, or for polish 38 above fair 44, the third NPE is equal to the second NPE.

The system then adjusts the NPE based on the presence of fluorescence 48. For a fluorescence 48 that is detectable 52, the third NPE is reduced by 5-25% to produce the fourth NPE. If none 54 is detectable, the forth NPE is equal to the third NPE.

The system then adjusts the NPE based on the depth 58 percentage of the diamond, i.e. the ratio of the diameter (measured at the girdle of the diamond) to the depth of the diamond (measured from the culet to the table). Each particular cut of diamond has a particular ideal range for this ratio, and the greater the deviation from this ratio, the more the NPE is discounted. For example, for a round brilliant diamond, the grade for depth percentage is from poor (ratio is over 66%), fair, (ratio is or near 65%), good (ratio is or near approximately 63%), excellent (ratio is or near 61%) to Ideal (approximately 59%).

The system then adjusts the NPE based on the table 59 percentage of the diamond, i.e. the ratio of the width of the table to the diameter at the girdle. For example, for a round brilliant diamond, the grade of table percentage is from poor (over 70%), fair (from approximately 64-70%), good (from approximately 60 to 64%), excellent (from approximately 58-60%), and ideal (from approximately 53-58%). For table percentage of fair or less, the NPE is reduced by 5-25%.

After adjustment of the IPE to produce a final NPE, the NPE may then be marked up by a reasonable percentage to reflect the retail sale price, provided that as carat size increases, the percentage of the markup decreases as overhead for the diamond may remain somewhat stable regardless of carat weight, to produce the fair market value (FMV) of the diamond. The FMV is then stored in a device readable and searchable media that is accessible by the system. When accessed by a diamond buyer that inputs criteria matching or within the parameters of cut grade, symmetry, polish, florescence, the system provides this FMV to the buyer along with the sellers address, phone number, or other means to contact the seller, such as a web address or link to a instant message system.

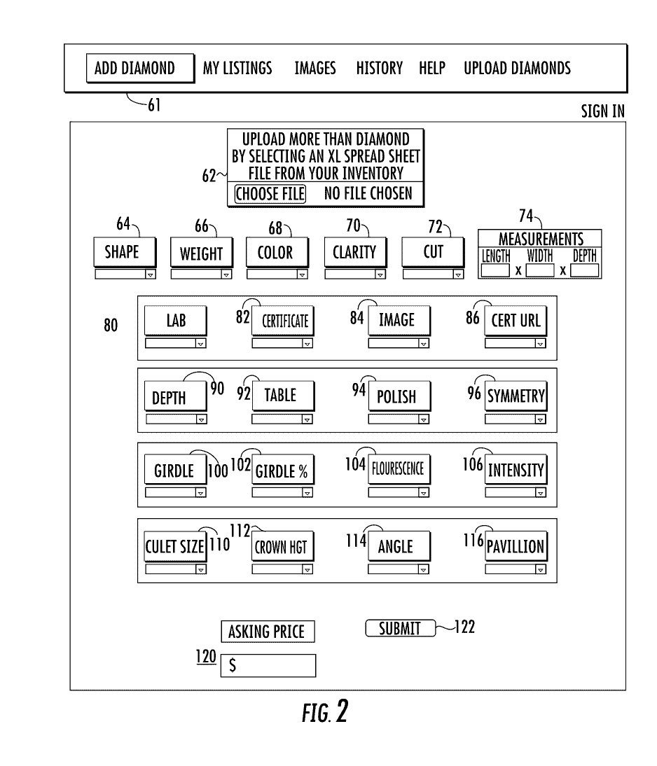

FIG. 2 depicts an exemplary seller upload form or input page of the system that is provided by the system to the seller and used by a diamond seller to upload the diamond's criteria, such as shape, carat weight, price, certificates if any, as well as seller address and contact information. This form would be programmed in HTML or other web compatible language, and may use entry elements or means typical for web page form design but adapted for use with the system of the invention to receive and store data on gem and seller characteristics, and may include but are not limited to text entry boxes, input buttons, such as radio buttons, checkboxes, pop up boxes and the like. In FIG. 2, header 61, is a series of navigation links where the user may select the shape from a predetermined list of commands to move to different web pages included in the system. Uploading a description of a diamond using by selecting Add Diamond to the sellers account, a stored listing associated with the seller that that the seller has uploaded to the system. The seller may also upload information about a set of diamonds with information previously stored in a compatible spreadsheet locally saved file using Choose File box 62, or enter the characteristics of an individual diamond as follows. Shape 64, Weight 66, Color 68, Clarity 70 and Cut 72 are pop up boxes used by the seller to enter the relevant criteria into the system. Further characteristics are entered into boxes that store information on the source of the information. Lab 80 is a pop up box where the seller identifies/selects the lab that performed the appraisal of the diamond whose criteria are being added to the system. Certificate 82 is a pop up box 82 for the entry of the type of certificate provided by the seller, while Image text box 84 is for the upload of an image of the certificate, or, in the alternative, a CertURL text box 86 is provided to enter store the uniform resource locator or web address containing a copy of the certificate as an image or document. Additional measurements for the diamond are entered in pop op boxes Depth 90, Table 92, Polish 94 Symmetry 96, Girdle 100, Girdle %, Florescence 104, Intensity 106, Culet Size 110, Crown Hgt [height] 112, Angle 114, and Pavilion 116. Asking Price text box 120 is a text box where the buyer enters the asking price. After filling in the form in whole or in part, the seller then uses the Submit button, and the system stores the information in the seller's account, associated with a product identification number selected by the buyer or assigned by the system. The system then emails the seller a document to confirm the entry of the information and listing of the diamond, where listing is the publication of the information by the system via a remote connection, preferably a website accessed by a web browser or application accessing a website.

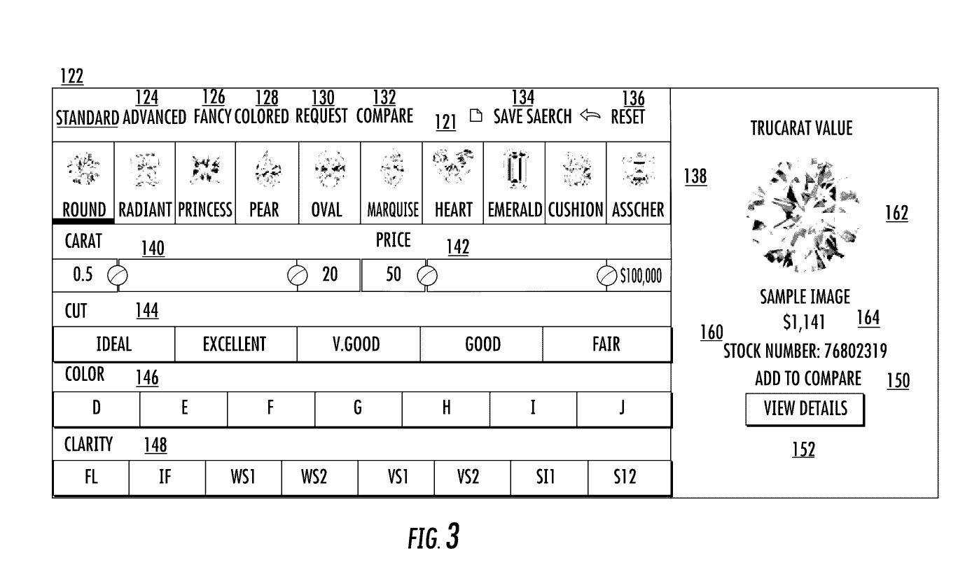

The searchable website is then used by the buyer (or potential buyer) to find the diamond that matches their budget and other purchase criteria. The buyer enters parameters for the characteristics into a form, such as the one depicted by FIG. 3.

In FIG. 3, navigation bar 121, provides navigation commands that can be selected by a mouse or other interface device. Text entry box 124 allows the buyer to enter a carat weight for the diamond they wish to find and appraised. Radio buttons 128 provide a means to select the shape or shapes of the diamonds to be searched and appraised, including Round Brilliant, Oval, Marquise, Pear, Heart, Emerald, Princess, and Radiant. Color radio buttons 130 provide a means to select the color or colors of the diamonds to be searched and appraised, from D to M. Clarity radio buttons 132 provide a means for the buyer to select the parameter for clarity, from IF to I3. Cut radio buttons 134 provide a means for the buyer to enter the parameter for the cut grade, from excellent to poor. Polish radio button 136 provides the means to enter the grade of polish, from excellent to poor. Symmetry radio buttons 138 provide a means to enter the symmetry of the diamond from excellent to poor, and Florescence radio buttons provide a means to enter the amount of florescence in the diamond. After selection of the aforementioned criteria, the buyer then presses Enter radio button 142, and the method provides the fair market value of the diamond meeting those criteria.

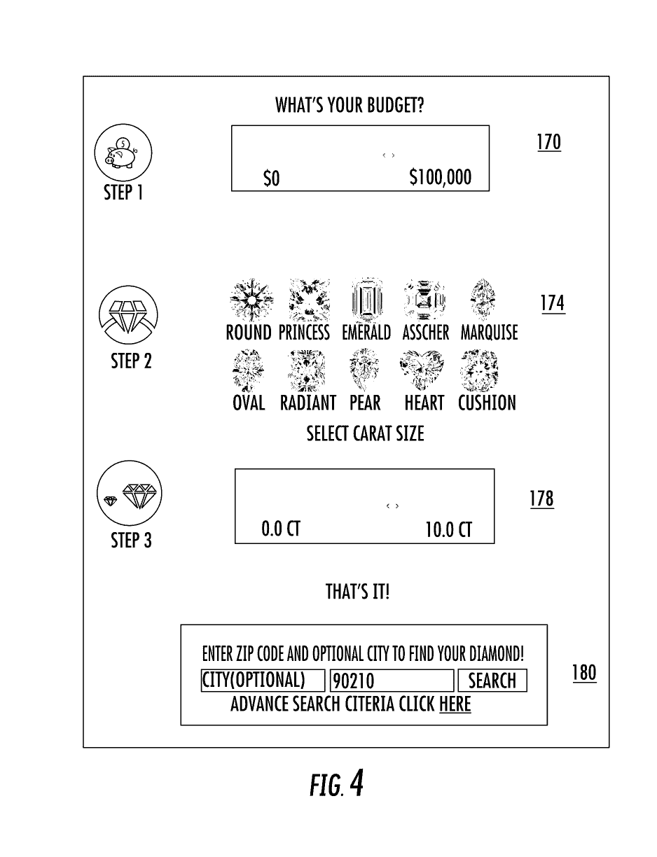

FIG. 4 displays a simplified buyer request form without results. Price input means 170 is used by the buyer to select and input the range of price of the diamond the buyer is looking to purchase. Shape selection radio button 172 is used by the buyer to select and input the shape or shapes of the diamond that they buyer is searching for, including round, princess, emerald, asscher, marquise, oval, radiant, pear, heart, and cushion. Carat size means 178 is used by the buyer to select and input the minimum and maximum size of the diamond. Address entry means 180 is used to enter the buyer's location.

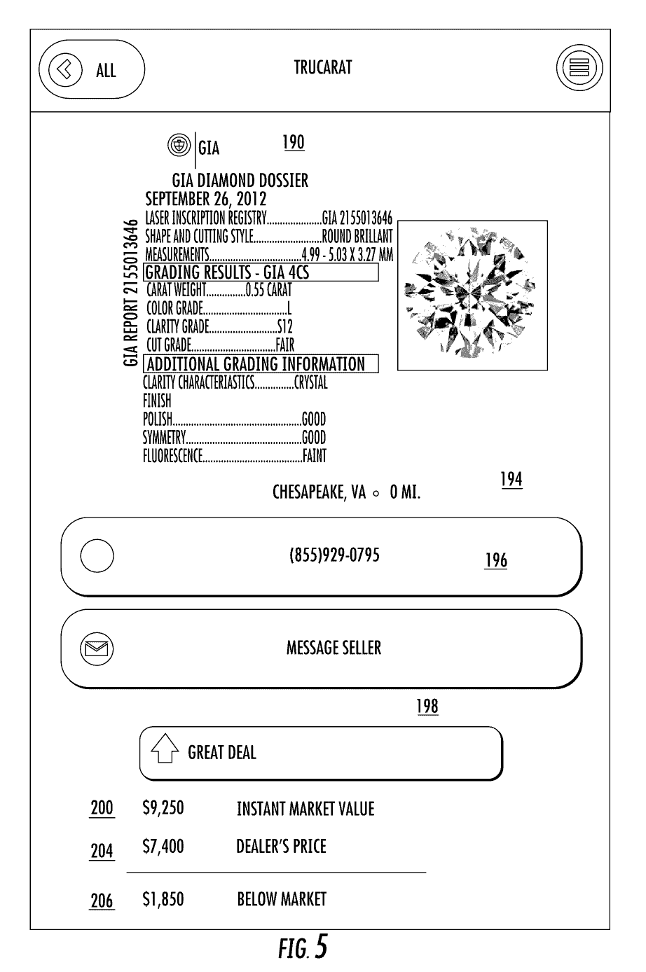

FIG. 5 is a display of an individual result provided by the system to the buyer following a request made by the buyer using a mobile device. The result includes a GIA report 190 describing a particular diamonds criteria, the seller's location 194, seller's phone number 196 and radio button 198 is a means to message the seller. Also provided are the fair market value 200 calculated by the system, seller's asking price 204, and the difference 206 between the two.

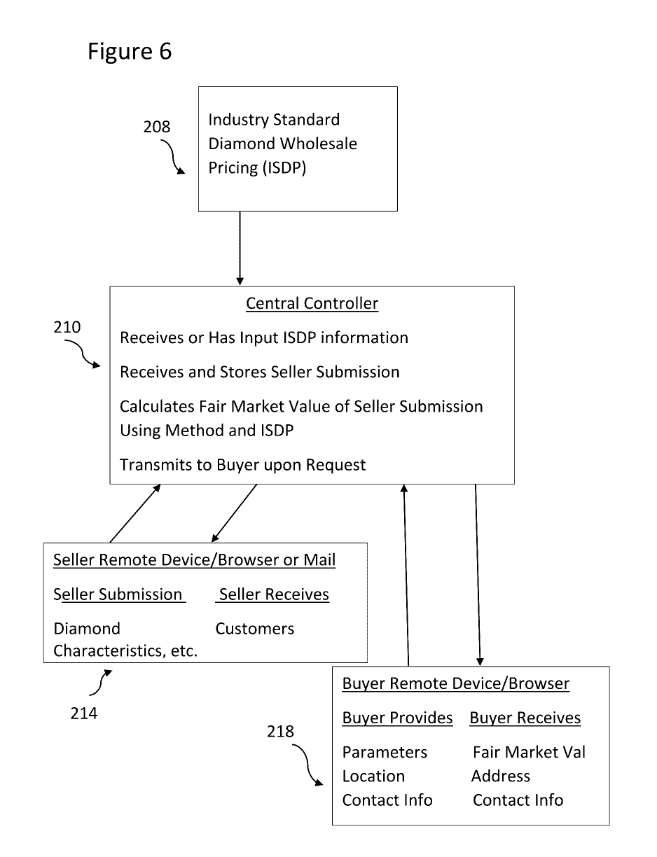

FIG. 6 is a schematic depiction of the system used to implement the method of diamond valuation. The system includes a central controller computer 210 that has memory storage is operably connected or connectable for data transfer to the sellers device 214, and the buyers device 218. These connections may be through wired connections but is typically via wireless router or modem via internet service provider. Central controller computer 210 may also be operably connected to the database 208 containing the ISDP information, or this information may be manually entered into the system via a keypad or character recognition scanner should the ISDP be electronically unavailable. By way of example, ISDP information is entered and stored into the memory of the central controller (or otherwise obtained electronically) in a database. A seller makes use of the system by submitting his or her address, and one or more diamonds and their characteristics as well as their certificates, if any. This information is also stored in a database, either a separate database or a in the same database, whichever is computationally most efficient. In one embodiment, each of the sellers diamonds characteristics is then analyzed by the foregoing method to provide its fair market value, and this value is stored with the diamonds characteristics and made available to the buyer which the buyer submits a request from the buyers remote device 218 having parameters that match the diamonds. The system then communicates the diamond's address, characteristics/certificate, location, seller contact information, and FMV to buyer, and optionally, send an alert the seller's remote device of the buyer's interest.

### EXAMPLES

### Example 1

This is an example of the difference in value between two diamonds with the same “4 C's” grading. Both are 1.0 carat princess cut GIA Certified diamonds that received a grading of VS2 clarity and E color. Based on these criteria, the industry accepted international wholesale market price, combined with the standard retail price adjustment, would value them equally at $8,875. The diamonds sellers enter and save or otherwise provide this information to the system and uploading or otherwise provide GIA certificates, including information related to polish, cut, rations, depth, table percentage, etc, as listed below. Further, the diamonds are entered and stored into the system of the invention by the two separate sellers and distinct locations. The system calculates the fair market value as follows in Table 1.

TABLE 1

| Diamond A | Diamond B |
|---|---|
| MEASURES: 5.3 mm × 5.0 mm × 4.05 mm | 5.55 m × 5.55 mm |
| | 3.80 mm |
| CUT: Good - 11% | CUT: Ideal |
| POLISH: Excellent | POLISH: Excellent |
| LGTH/WDTH RATIO: 1.06 - 10% | LGTH/WDTH: 1.02 -5% |
| DEPTH: 79.6% | DEPTH: 71.1% |
| TABLE: 76.0% | TABLE: 71.0% |
| SYMMETRY: Very Good - 12% | SYMMETRY: Excellent |
| CULET: None | CULET: None |
| GIRDLE: Thick - 7% | GIRDLE: Thin |
| FLUORESENCE: None | FLUORESENCE: None |

In the above example, the system calculates the fair market value of diamond A as $5,325.00 USD, and diamond B as $8,431.00. USD.

A buyer accesses the system by loading the system's buyer web page form and enters the criteria for a diamond having the cut carat and quality of diamonds A & B. The system then provides the buyer with the FMV of both diamonds, and the location of the seller of each diamond.

### Example 2

This is an example of the difference in value between two diamonds with the same “4 C's” grading. Both are 1.50 carat, round brilliant cut GIA Certified diamonds that received a grading of VVS2 clarity and E color. Based on these criteria, the industry accepted international wholesale market price, combined with the standard retail price adjustment, would value them equally at $29,340 The diamonds' sellers enter and save or otherwise provide this information to the system and upload or otherwise provide copies of the GIA certificates, including information related to polish, cut, rations, depth, table percentage, etc, as listed below. Further, the diamonds are entered and stored into the system of the invention by the two separate sellers and distinct locations. The system calculates the fair market value as follows in Table 2.

TABLE 2

| Diamond A | Diamond B |
|---|---|
| MEASURE 7.15 mm × 7.18 mm × 4.58 mm | 7.42 m × 7.45 mm |
| | 4.49 mm |
| CUT: Very Good - 9% | CUT: Excellent |
| POLISH: Excellent | POLISH: Excellent |
| DEPTH: 63.9% - 8% | DEPTH: 61.5% |
| TABLE: 58.0% | TABLE: 57.0% |
| SYMMETRY: Very Good - 6% | SYMMETRY: Excellent |
| CULET: None | CULET: Very Small |
| GIRDLE: Slightly Thick to thick - 2% | GIRDLE: Thin/Med. |
| FLOURESENCE: Strong - 19% | FLOURESENCE: None |

In the above example, the system calculates the fair market value of diamond A as $16,430.00 USD, and diamond B as $29,340.00. USD.

A buyer accesses the system by loading the system's buyer web page form and submits the criteria for a diamond having the cut carat and quality of diamonds A & B and the buyers location, either by entry of the buyers address, or by GPS using a GPS enabled mobile device. The buyer also enters a geographic limitation (distance from the buyer) The system then identifies diamonds being offered for sale within the geographic area specified by the buyer, and provides the buyer with the name and address of both sellers as well as the FMV of both diamonds.

Although the present disclosure has been described with respect to one or more particular embodiments, it will be understood that other embodiments of the present disclosure may be made without departing from the spirit and scope of the present disclosure, whose limits are to be found in the following claims.

We claim:

1. A method for valuation and publication of a diamond's market value and connecting diamond purchasers to sellers, comprising the method of:
the invention relates a method and system for valuation and publication of a diamond's market value and connecting diamond purchasers to sellers, comprising,
providing at least one submission by a diamond seller, the submission comprising an asking price for the diamond, the seller's geographic location, and a set of identifying characteristics of the diamond including at least one of the diamond's shape, cut grade, color, clarity and the carat weight (mass);
storing the at least one submission in a computer readable media, wherein the estimate, geographic location and identifying characteristics are stored in a database and organized in the readable media such that all of the submissions in the readable media may searched according to these characteristics;
acquiring an international standard wholesale price (ISWP) for the diamond in the readable media;
adjusting the standard wholesale price up or down based on the diamond's identifying characteristics to produce a fair market value for the diamond, and optionally, storing the fair market value in the database readable media; and
transmitting the fair market value to a buyer.

2. The method of claim 1, wherein the step of transmitting the fair market value includes the steps of a buyer accessing said readable media from a remote location using a browsing device, wherein said step of accessing said readable media is performed by a buyer using an application or web browser operating on said browsing device; inputting a request by a buyer for a diamond, said request including price, geographic location and comprising at least one parameter, the parameter including, at least one of an upper or lower boundary for price, color, carat; cut style and cut quality; comparing the request with the stored submissions and retrieving at least one submission that falls within the location and parameters of the request; transmitting from the readable media onto the browsing device the at least one submission, including the asking price, the fair market value, and seller's location; and displaying the at least one submission, fair market value, and seller's location on the browsing device.

3. The method of claim 1, further comprising the steps of: accessing said readable media from a remote location using a browsing device, wherein said step of accessing said readable media is performed by a buyer using an application or web browser operating on said browsing device; inputting a request by a buyer for a diamond, said request including price, geographic location and comprising at least one parameter, the parameter including, at least one of an upper or lower boundary for price, color, carat; cut style and cut quality; comparing the request with the stored submissions and retrieving at least one submissions that falls within the location and parameters of the request; transferring from the readable media onto the browsing device the at least one submission, including the asking price, the fair market value, and seller's location; and displaying the at least one submission, asking price, fair market value, and address on the browsing device

4. A system for valuation and publication of a diamond's market value and connecting diamond purchasers to sellers using the method of claim 1, comprising
a computer having device readable media having a database containing information associated with diamonds, each diamond having an associated seller, location, and identifying characteristics, and fair market value, and also comprising a set of operating instructions for calculating said fair market value, searching the database, retrieving and transmitting this information to a buyer upon the buyer's request.

5. The system of claim 4, further comprising a first remote device, said remote device in electronic communication with the central controller and submitting a seller submission comprising information on at least one diamond.

6. The system of claim 5, further comprising a second remote device, said second remote device having a web browser or an application comprising a set of commands for accessing the central controller, providing parameters for a diamond to be purchased, and obtaining at least diamond's information.

7. The method of claim 1, further comprising the steps of performing the method having the steps of receiving and recording at least one submission by a diamond seller, the submission comprising an asking price for the diamond, the seller's geographic location, and a set of identifying characteristics of the diamond including the diamond's shape, cut grade, color, clarity and the carat weight (mass);
storing the at least one submission in a device having readable media, wherein buyer information, estimate, geographic location and identifying characteristics are stored in a database in the readable media; acquiring an international standard wholesale price for the diamond and storing this price in the database;
adjusting the standard wholesale price up or down based on the diamond's identifying characteristics to produce a fair market value for the diamond,
and storing the fair market value in the device readable media along with the diamond's characteristics.

8. The method of claim 1, wherein the submissions are to diamonds with color graded M or higher.

9. The method of claim 8, wherein the submissions are to only white diamonds.

10. The method of claim 1, wherein the submission further comprises cut grade, girdle, table percentage and depth percentage.

11. The method of claim 2, wherein step of displaying the submission includes displaying the geographic location of the diamond on a map.

12. The method of claim 11, wherein the step of displaying the at least one submission includes displaying the fair market value and the price on a map.

13. The method of claim 2, wherein the step of displaying the at least one submission also includes displaying an electronic copy of a certificate.

14. The method of claim 13, wherein the certificate is issued by the GIA, HRD, or AGS.
